(19) United States
(12) Patent Application Publication
(10) Pub. No.: US 2018/0198831 A1
(43) Pub. Date: Jul. 12, 2018

(54) PROACTIVE CHATTING AND INSTANT MESSAGING GROUP MANAGEMENT

(71) Applicant: International Business Machines Corporation, Armonk, NY (US)

(72) Inventors: Jeffrey A. Calcaterra, Chapel Hill, NC (US); Romelia H. Flores, Keller, TX (US); Zhi Li Guan, Beijing (CN); Su Liu, Austin, TX (US)

(21) Appl. No.: 15/404,067

(22) Filed: Jan. 11, 2017

(51) Int. Cl. H04L 29/06; H04L 12/58; H04L 29/08; H04L 12/18

(52) U.S. Cl. CPC H04L 65/403; H04L 51/04; H04L 51/32; H04L 67/10; H04L 12/1822; H04L 65/1093; H04L 67/306; H04L 67/22; H04L 65/1069

(57) ABSTRACT

In one embodiment, a system includes a processing circuit and logic integrated with the processing circuit, executable by the processing circuit, or integrated with and executable by the processing circuit. The logic is configured to cause the processing circuit to determine whether overlap of a first context status of a first user and a second context status of a second user exceeds a predetermined threshold. The first user and the second user belong to a plurality of users in a network. The logic is also configured to cause the processing circuit to create a group chat session in response to a determination that the overlap of the first and second context statuses exceeds the predetermined threshold. Moreover, the logic is configured to cause the processing circuit to add the first user and the second user to the group chat session in response to creation of the group chat session.

### BACKGROUND

The present invention relates to proactive chat and instant message group management and creation.

Applications that allow for exchanging messages with other users in a chat session (chatting) and/or exchanging instant messages (IMs) with other users are useful for the exchange of ideas. Many of the applications that allow for chatting and IMs utilize some sort of filter to ensure that users would benefit from or otherwise appreciate the exchange of information, such as a shared interest in a focused topic, some current event, receiving news in a travel setting like an airport, alert messages, etc.

Social media networks and chatting applications are very popular among conventional technology consumers as forms of communication, and there are many hundreds of such applications, many that are specific to particular languages, communities, interests, businesses, etc.

When using these applications, the way in which a group is formed is able to enhance or detract from the use of the application, and the usefulness of the exchange of data. In some conventional chatting applications, users are allowed to create a group chat room to share text and voice messages, videos, pictures, etc. However, these group chat rooms are not created without action on the part of the user to initiate the creation of the room, based on some input from the user(s). In other conventional chatting applications, users are allowed to initiate group chatting by selecting friends in a contact list, or via a “face-to-face” feature that allows a group chat room to be setup.

However, keeping sensitive information about the users secure is a concern with these conventional chatting applications and social media networks during group creation. Moreover, the act of creating a group chat session is also typically not user friendly. For example, on one particular chatting service application, a user desiring to setup a group chat session manually selects members from a contact list that must already be populated with contact information for one or more additional users on the chatting service application. Also, all group members must either be friends of an originator of the group or an invitee. Anyone who wants to join a group chat session must manually search for an interested group, scan a unique group Quick Response (QR) code, or input a security passcode (via “face-to-face” group setup).

Currently, simple and intuitive anonymous group chat setup does not exist using conventional social media networks and chatting applications, nor any way to add appropriate users to the group chat session based on a task and/or topic that takes into account individual user's personal context and characteristics.

### SUMMARY

In one embodiment, a system includes a processing circuit and logic integrated with the processing circuit, executable by the processing circuit, or integrated with and executable by the processing circuit. The logic is configured to cause the processing circuit to determine whether overlap of a first context status of a first user and a second context status of a second user exceeds a predetermined threshold. The first user and the second user belong to a plurality of users in a network. The logic is also configured to cause the processing circuit to create a group chat session in response to a determination that the overlap of the first and second context statuses exceeds the predetermined threshold. Moreover, the logic is configured to cause the processing circuit to add the first user and the second user to the group chat session in response to creation of the group chat session.

In another embodiment, a computer program product includes a computer readable storage medium having program instructions embodied therewith. The embodied program instructions are executable by a processing circuit to cause the processing circuit to determine, by the processing circuit, whether overlap of a first context status of a first user and a second context status of a second user exceeds a predetermined threshold, with the first user and the second user belonging to a plurality of users in a network. The embodied program instructions are also executable to cause the processing circuit to create, by the processing circuit, a group chat session in response to a determination that the overlap of the first and second context statuses exceeds the predetermined threshold. Also, the embodied program instructions are executable to cause the processing circuit to add, by the processing circuit, the first user and the second user to the group chat session in response to creation of the group chat session.

In yet another embodiment, a method includes determining whether overlap of a first context status of a first user and a second context status of a second user exceeds a predetermined threshold, with the first user and the second user belonging to a plurality of users in a network. The method also includes creating a group chat session in response to a determination that the overlap of the first and second context statuses exceeds the predetermined threshold. Moreover, the method includes adding the first user and the second user to the group chat session in response to creation of the group chat session.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a server-side architecture, according to one embodiment.

FIG. 5 shows a block diagram of a user-side architecture, according to one embodiment.

FIG. 6 shows a block diagram depicting a system that includes the server-side architecture interacting with the user-side architecture in accordance with one embodiment.

FIG. 7 shows a flowchart of a method, according to one embodiment.

FIG. 8 shows a flowchart of a method, according to another embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “about” as used herein indicates the value preceded by the term “about,” along with any values reasonably close to the value preceded by the term “about,” as would be understood by one of skill in the art. When not indicated otherwise, the term “about” denotes the value preceded by the term “about” ±10% of the value. For example, “about 10” indicates all values from and including 9.0 to 11.0.

The following description discloses several preferred embodiments of systems, methods, and computer program products that provide proactive chat and instant message (IM) group management. Most social media applications are capable of creating a chat or IM group based on shared interests, experience, hobbies, etc. For instance, matching algorithms deployed on various dating sites and social networks are well known applications capable of creating groups based on predetermined criteria. However, creation of these groups using conventional systems is a manual, non-intuitive, and reactive process. In chat group sessions, particularly those which allow for anonymous chatting to improve security for those in the chat session(s), cognitive, automated, and proactive chat grouping is not possible using conventional approaches.

In one general embodiment, a system includes a processing circuit and logic integrated with the processing circuit, executable by the processing circuit, or integrated with and executable by the processing circuit. The logic is configured to cause the processing circuit to determine whether overlap of a first context status of a first user and a second context status of a second user exceeds a predetermined threshold. The first user and the second user belong to a plurality of users in a network. The logic is also configured to cause the processing circuit to create a group chat session in response to a determination that the overlap of the first and second context statuses exceeds the predetermined threshold. Moreover, the logic is configured to cause the processing circuit to add the first user and the second user to the group chat session in response to creation of the group chat session.

In another general embodiment, a computer program product includes a computer readable storage medium having program instructions embodied therewith. The embodied program instructions are executable by a processing circuit to cause the processing circuit to determine, by the processing circuit, whether overlap of a first context status of a first user and a second context status of a second user exceeds a predetermined threshold, with the first user and the second user belonging to a plurality of users in a network. The embodied program instructions are also executable to cause the processing circuit to create, by the processing circuit, a group chat session in response to a determination that the overlap of the first and second context statuses exceeds the predetermined threshold. Also, the embodied program instructions are executable to cause the processing circuit to add, by the processing circuit, the first user and the second user to the group chat session in response to creation of the group chat session.

In yet another general embodiment, a method includes determining whether overlap of a first context status of a first user and a second context status of a second user exceeds a predetermined threshold, with the first user and the second user belonging to a plurality of users in a network. The method also includes creating a group chat session in response to a determination that the overlap of the first and second context statuses exceeds the predetermined threshold. Moreover, the method includes adding the first user and the second user to the group chat session in response to creation of the group chat session.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

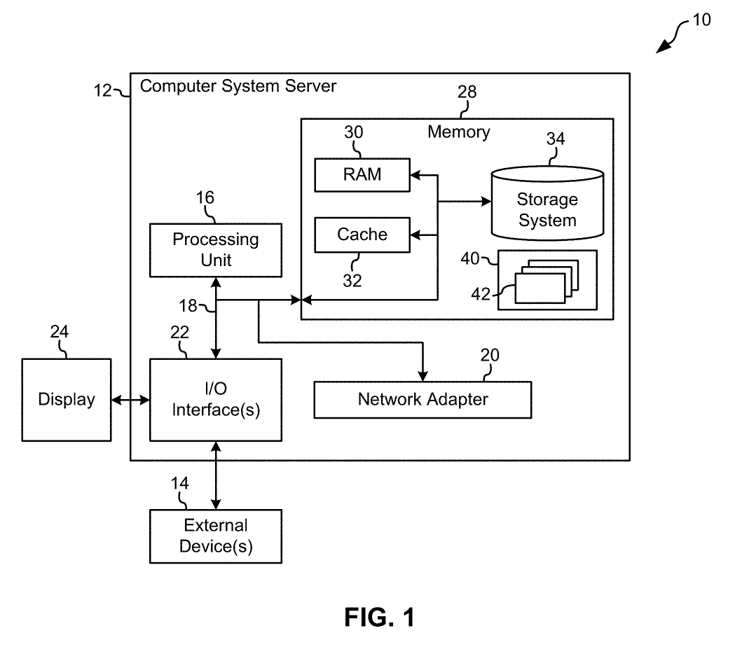

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

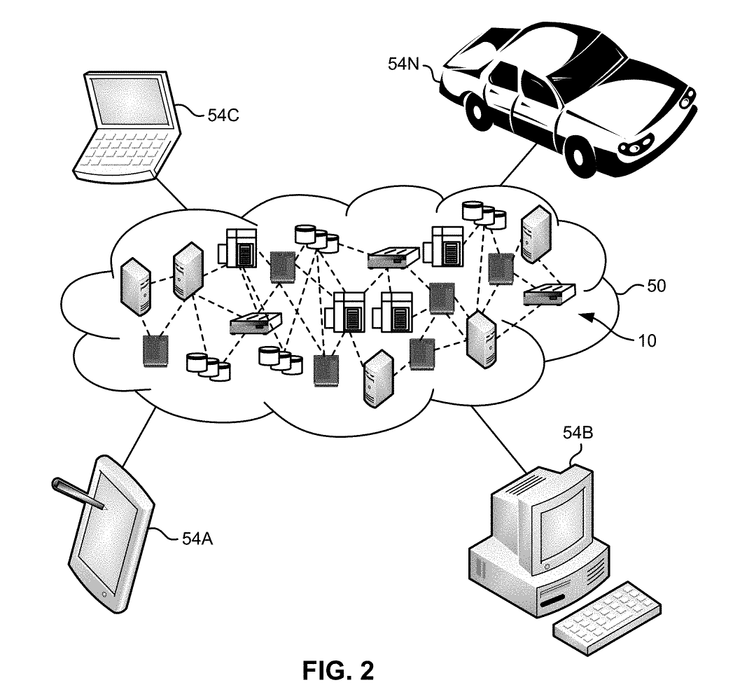

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

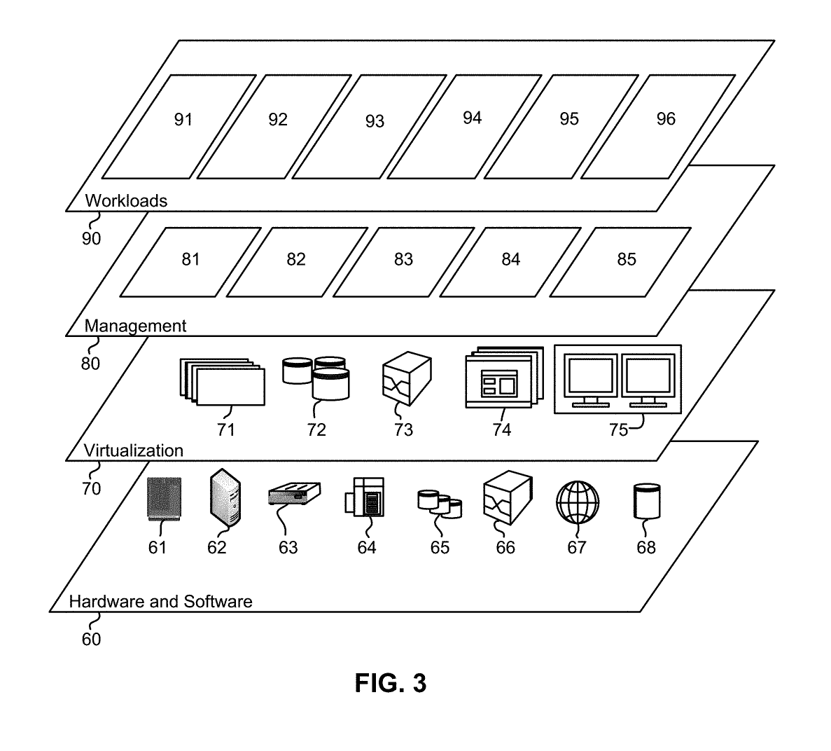

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and proactive instant messaging and chatting group management 96.

In order to provide proactive instant messaging and chatting group management, cognitive group management is utilized for securely grouping users in a virtual chat room without exposing sensitive personal information of any of the users. The cognitive group management is provided via a server which communicates with an application operating on a users' devices, and provides a temporary chat group service, e.g., provides a framework and application programming interfaces (APIs) for specific operating systems/architectures.

In a further embodiment, the cognitive group management defines customizable temporary chat group construction rules, and constructs a customizable temporary virtual chat group platform, reactively, according to users' characteristics in real time. Also, the cognitive group management configures users' privacy settings and limits exposure of user's sensitive personal information in accordance with predefined privacy levels.

In more embodiments, the cognitive group management tracks and stores personal temporary chat contents and grouping history to improve user experience when engaging in group chatting.

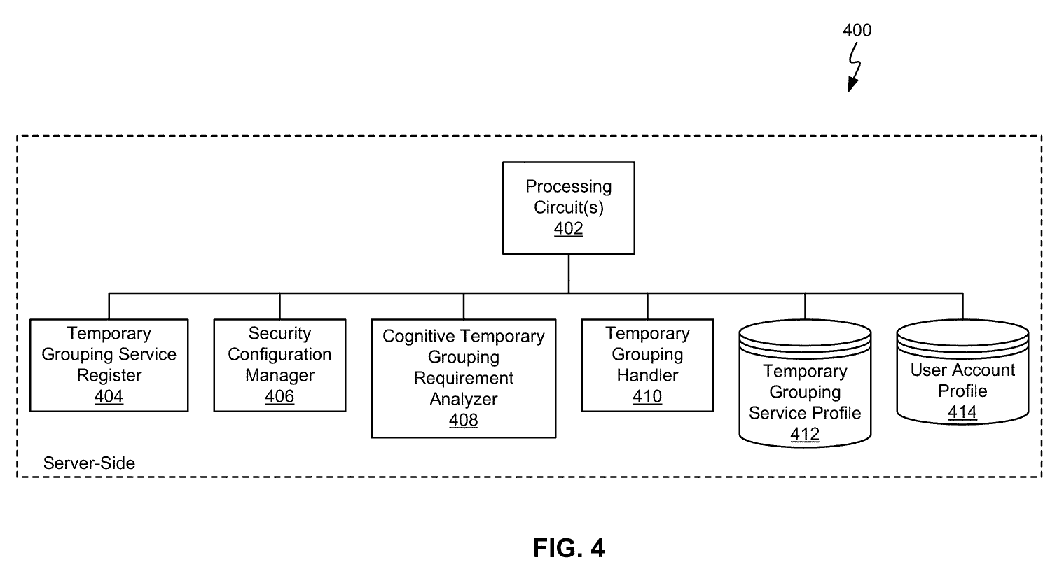

Now referring to FIG. 4, a block diagram of a server-side architecture 400 is shown according to one embodiment. The server-side architecture 400 is configured to provide proactive cognitive IM and chat group management that securely groups users in a virtual chat session without exposing sensitive personal information of the users.

The server-side architecture 400 includes a processing circuit 402 that is configured to execute one or more processes, create one or more results, and/or provide one or more services. In one embodiment, the processes, results, and/or services include, but are not limited to, a temporary grouping service register 404, a security configuration manager 406, a cognitive temporary grouping requirement analyzer 408, a temporary grouping handler 410, a temporary grouping service profile 412, and a user account profile 414. The temporary grouping service profile 412 and the user account profile 414 may be stored to one or more computer readable storage media, as would be known in the art, such as hard disk, tape, optical disk, RAM, ROM, nonvolatile memory (NVM) such as Flash, etc. As shown in FIG. 4, the temporary grouping service profile 412 is stored to a first memory, while the user account profile 414 is stored to a second memory, but they may be stored to the same memory, spread across more than one memory, etc.

The processing circuit 402 may include one or more suitable processing units, such as a microprocessor, a CPU, an ASIC, a FPGA, etc., combinations thereof, or any other suitable computing device known in the art. Moreover, one or more separate processing circuits may be provided that are configured to perform, individually, one or more of the processes and/or services described herein with respect to FIG. 4. For example, each of the individual services may have their own dedicated processing circuit to perform the functionality of the service, as would be apparent to one of skill in the art upon reading the present descriptions.

The temporary grouping service register 404 is configured to register users that either request to be included in the temporary grouping service, or are proactively identified as being interested in entering into a secure group chat session such that a secure group chat session service is provided to the registered users. A registered user may not receive any invitations to enter into a secure group chat session, but the opportunity to provide such group chat sessions is provided when the user registers and is included in the temporary grouping service register 404.

The security configuration manager 406 is a user interface for users to configure personal settings of a user account associated with the user. The personal settings of the user account may be used in a process of determining whether the user associated with the user account should be included in a particular group chat session. In one embodiment, the personal settings may include, but are not limited to, privacy settings which dictate which sensitive information is available for sharing with other users, access levels which may be used to dictate that more sensitive information is available to users which are more highly trusted based on past interactions therewith, sensitive information sharing restrictions which may be based on the type of sensitive information, e.g., identification (ID) of the user, name of the user, photo of the user, location of the user, address of the user, age of the user, contact information for the user (e.g., phone number, email address, etc.), etc.

The cognitive temporary grouping requirement analyzer 408 is configured to calculate context changes for users to determine a context status, determine whether a context status of certain users are overlapping with one another, and send a request to form a group chat session to the temporary grouping handler 410 in response to overlapping context statuses being identified. The context status is a marker which indicates topics of interest to a particular user, and as such, each context status may be unique for each particular user, as no two users are identical, based on differences in location, age, gender, orientation, likes, dislikes, friends, family, etc. Of course, there is a possibility that two users may share an overwhelming amount of similar interests, and the context statuses for each of these users would be overlapping by a substantial amount. With users who do not share any interests, there will be no overlap of context statuses between these users.

Also, the cognitive temporary grouping requirement analyzer 408 is configured to monitor the usage statistics of users within a group chat session. The usage statistics may include, but are not limited to, length of time that a user is a part of the group chat session, how active a user is within the group chat session (sent message frequency). These usage statistics may be used on a per-user and/or a per-group chat session basis to determine and adjust threshold(s) used in determining users to add to the group chat session.

The temporary grouping handler 410 is configured to group at least two users together in a group chat session according to input from the cognitive temporary grouping requirement analyzer 408. The temporary grouping handler 410 is further configured to periodically update an assigned grouping status for each user in the network according to whether the user is a member of a one or more group chat sessions, along with an identifier of which group chat session(s) each user is a member of, if any at all. Moreover, users who join a group chat session have their associated grouping status updated to reflect the new group membership, and when no users are part of a particular, previously established group chat session, the empty group chat session is destroyed as a result of no overlapping context statuses being indicated by any of the users in the network.

The temporary grouping service profile 412 is a record, file, spreadsheet, list, table, or database that is configured to store service settings for a particular entity that operates the server-side architecture 400. The temporary grouping service profile 412 may store predefined temporary grouping service rules and a context aware analysis algorithm that is applied to the context status of users and is used to determine overlapping interests.

The user account profile 414 is a record, file, spreadsheet, list, table, or database that is configured to store user personal group settings, and is stored to a memory as described previously. The user account profile 414 may include, but is not limited to, personal settings of user accounts associated with the users registered to utilize the proactive group chat service and present within the network.

The server-side architecture 400 may be operated from a computer platform that is remote from user devices, such as from a server to provide server-client operations, as a cloud service, as a web-based service accessible via the Internet, etc., or within a network, sub-network, or a user device, such as an application operating within a subnetwork local to one or more user's devices, as an application operating on a user's device, etc.

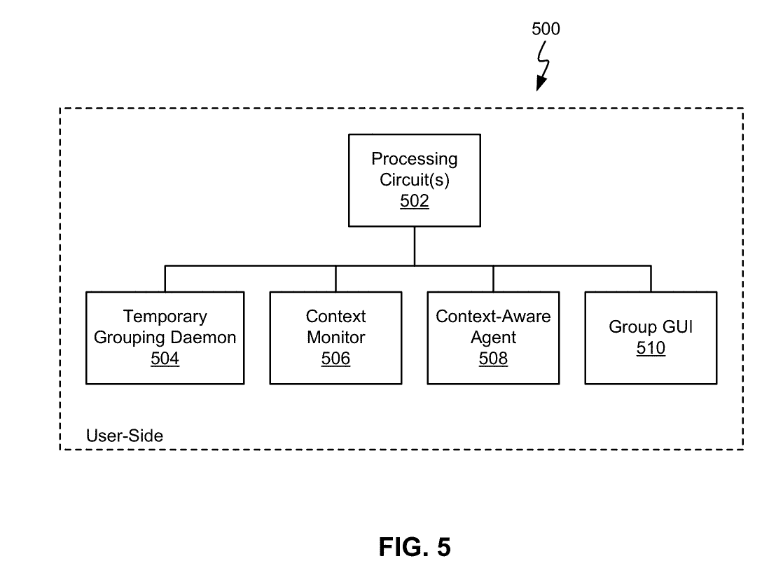

With reference to FIG. 5, a block diagram of a user-side architecture 500 is shown according to one embodiment. The user-side architecture 500 is configured to allow proactive cognitive IM and chat group management to be provided to the user such that a user on a user device may be grouped together with other users in a virtual chat session without exposing sensitive personal information of the user.

The user-side architecture 500 includes at least one processing circuit 502 that is configured to execute one or more processes, create one or more results, and/or provide one or more services. In one embodiment, the processes, results, and/or services include, but are not limited to, a temporary grouping daemon 504, a context monitor 506, a context-aware agent 508, and a group graphical user interface (GUI) 510.

The processing circuit 502 may include one or more suitable processing units, such as a microprocessor, a CPU, an ASIC, a FPGA, etc., combinations thereof, or any other suitable computing device known in the art. Moreover, one or more separate processing circuits may be provided that are configured to perform, individually, one or more of the processes and/or services described herein with respect to FIG. 5.

The grouping daemon 504 operates on the user device and is configured to manage any grouping related service requests and received information. These requests may be sent to and/or received from a corresponding temporary grouping handler within a server-side architecture, in one approach.

The context monitor 506 is one or more hardware and/or software modules (e.g., event handlers) configured to track context (e.g., interested topics, personal information, etc.) for the user and detect context changes. This information may be used to update the context status of the user, which in turn may be used to determine group chat session inclusion for the user.

The context-aware agent 508 is a subroutine configured to analyze the context status (user-defined characteristics, events, notifications, and/or new types of communication requests, as defined by the user profile). In response to the context-aware agent 508 determining that a contextual event has achieved a pre-defined threshold, the context-aware agent 508 sends a context change signal to the grouping server, such as that shown in FIG. 4, to trigger a temporary grouping action to occur.

Referring again to FIG. 5, the group GUI 510 is a representative visual environment that is configured to display messages from users within the group chat session, allow messages to be sent by the user, and display static and/or interactive information to the user, such as options to join, chat, and leave a group chat session.

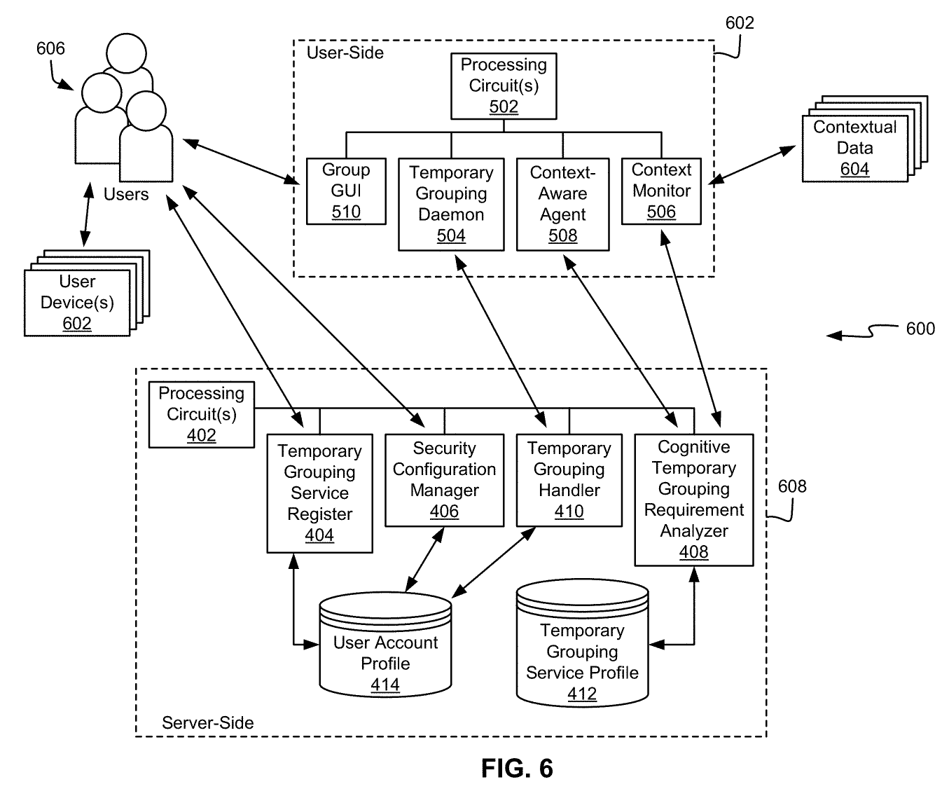

FIG. 6 is a block diagram depicting a system 600 that includes a server-side architecture operated on a server 608 interacting with a user-side architecture operated on a user device 602 in accordance with one embodiment. As shown, the user-side architecture may be implemented on any user device 602 known in the art, such as a smartphone, a tablet computer, a notebook computer, an e-reader, etc. Moreover, the server-side architecture may be implemented on any server 608 or host known in the art, and may utilize one or more storage memories of a type known in the art, such as hard disk, tape, optical disk, RAM, nonvolatile memory, etc.

As a user consumes news, reports, emails, texts, and other information (collectively referred to as contextual data) 604 on the user device 602, the context monitor 506 determines context data from the consumption of and interaction with this contextual data 604, to provide a context status for the user, which is fed back to the cognitive temporary grouping requirement analyzer 408 of the server-side architecture operating on a server 608 or other suitable operating environment.

The cognitive temporary grouping requirement analyzer 408 analyzes the context status for a plurality of users 606, each using their own user device 602, in accordance with temporary grouping service rules and at least one context aware analysis algorithm (which are stored in a temporary grouping service profile 412 on a memory), to create one or more group chat session requests which are sent to the temporary grouping handler 410. The temporary grouping handler 410 determines whether a subgroup of users have security profiles that allow them to join a group chat session according to user account profiles 414 stored to a memory. In response to the subgroup of users having security profiles that allow them to join the group chat session, the temporary grouping handler 410 creates and manages the group chat session for all of the users in the subgroup, and corresponds through the grouping daemon 504 on each user device 602. Each user 606 in the group chat session interacts with the other users via the group GUI 510, which is configured for sending and receiving IMs and chat messages.

In response to detecting a context status change of a user, the context-aware agent 508 sends a context change signal to the cognitive temporary grouping requirement analyzer 408 which may cause a user's context status to fall below predetermined threshold for inclusion in a group chat session, or may cause a user's context status to be elevated above the predetermined threshold for inclusion in the group chat session. Either way, this context change signal is received by the cognitive temporary grouping requirement analyzer 408 and appropriate action is taken.

The user account profiles 414 stored in the server-side architecture are created and updated based on input from the users 606 through the security configuration manager 406 and the temporary grouping service register 404. The users 606 adjust their security settings and levels, which are reflected in the user account profiles 414 for each individual user 606. Moreover, membership in group chat sessions are indicated to the temporary grouping service register 404 and reflected in the user account profiles 414 for each individual user 606.

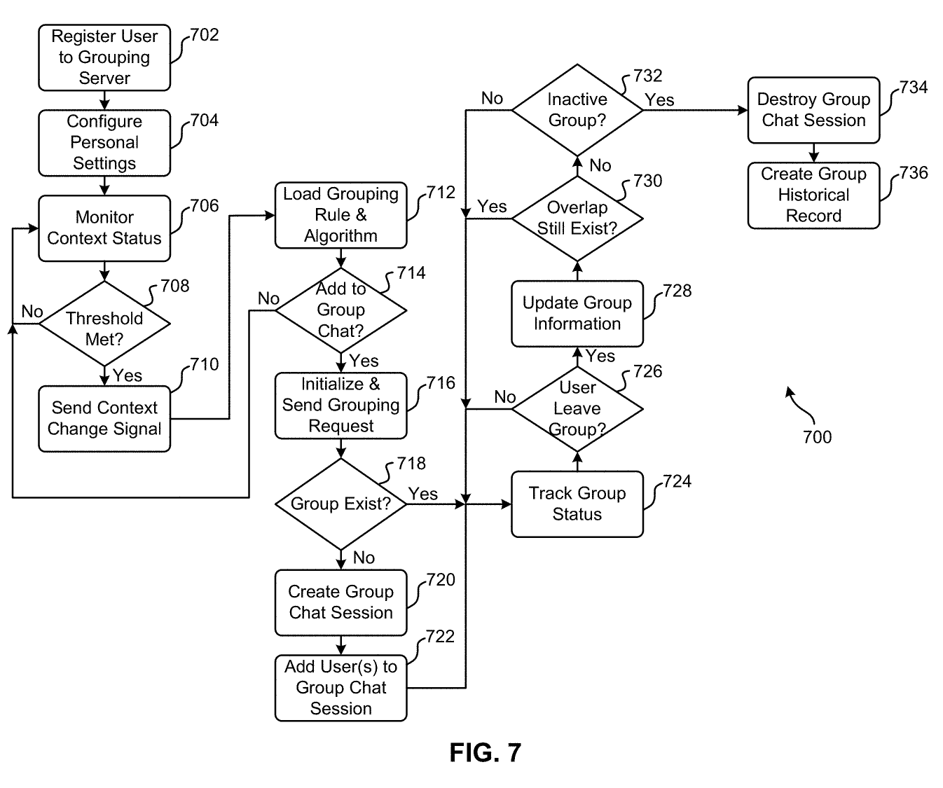

Now referring to FIG. 7, a method 700 is shown according to one embodiment. The method 700 may be performed in accordance with the present invention in any of the environments depicted in FIGS. 1-6, among others, in various embodiments. Of course, more or less operations than those specifically described in FIG. 7 may be included in method 700, as would be understood by one of skill in the art upon reading the present descriptions.

Each of the steps of the method 700 may be performed by any suitable component of the operating environment. For example, in various embodiments, the method 700 may be partially or entirely performed by a cloud server, a portable computer, a handheld or wearable computer, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more steps of the method 700. Illustrative processors include, but are not limited to, a microprocessor, a CPU, an ASIC, a FPGA, etc., combinations thereof, or any other suitable computing device known in the art.

As shown in FIG. 7, method 700 may start with operation 702, where a user registers with a grouping server such that the grouping server is able to monitor and adjust group chat session admission(s) for the user.

In operation 704, the user configures personal settings within a user account profile that includes security settings, security levels, etc., and may be used for determining whether a user should be added or removed from a group chat session.

In operation 706, context events are tracked for the user, such as via a group daemon operating on the user's device, with a context status being created that represents the various contextual choices associated with the user. These contextual choices include location, interests, groups, dislikes, friends, associates, family members, etc.

Operation 708 determines whether a predefined threshold has been met with regard to the context status of the user. When the threshold has been met, method 700 continues to operation 710; otherwise, method 700 returns to operation 706 to continue monitoring context status of the user.

In operation 710, a context change signal is sent to the grouping server based on the threshold being met. The grouping server loads a grouping rule and at least one context aware analysis algorithm in operation 712, and in operation 714, determines whether the user qualifies to be added to any group chat sessions. This determination is based, at least in part, on analysis of whether context statuses of two or more users overlap to a degree that exceeds a predetermined threshold. For example, the threshold may be >50% overlap of context status, >60%, >75%, etc., or an overlap of a predetermined number of characteristics that form the context status, such as >6 characteristics, >10 characteristics, >12 characteristics, etc., which may be based on a number of characteristics that are included in the context status.

In operation 716, in response to the users' context statuses overlapping above the predetermined threshold, a grouping request is initialized, participant (the users) security configurations are loaded, and the grouping request is sent to each user whose security configuration allows for the request to be received. In response to the users' context statuses not overlapping above the predetermined threshold, method 700 returns to operation 706 to continue tracking context events.

According to operation 718, it is determined whether a group chat session already exists for the shared context status of the users who qualify to have the grouping request sent. In response to the group chat session already existing, method 700 continues to operation 724 to track a group status, which includes monitoring the users in the group chat session, their actions (messages sent/received, a level of participation for users in the group chat session, etc.). In response to the group chat session not existing, a corresponding group chat session is created in operation 720 and the user(s) are added to the group chat session in operation 722. Then, method 700 continues to operation 724 to track the group status of the group chat session.

In operation 726, it is determined whether a user has chosen to leave the group chat session. In response to the user choosing to leave the group chat session, group information is updated to reflect this departure of a user from the group chat session in operation 728, and it is determined in operation 730 whether overlap still exists above the threshold level for the remaining users in the group chat session. In response to no users leaving the group chat session, method 700 returns to operation 724 to track the group status of the group chat session.

In response to overlap still existing at the prescribed level in operation 730, method 700 returns to operation 724 to continue tracking the group status. In response to insufficient overlap of context status, in operation 732, it is determined whether the group chat session is inactive, which is determined, at least in part, on whether activity has occurred from any of the users within a predetermined previous period of time.

In response to the group chat session being active, method 700 returns to operation 724 to track the group status of the group chat session.

In response to a determination that the group chat session is inactive, in operation 734, the group chat session is destroyed, deleted, or otherwise removed from service, and an historical group chat session record is created in operation 736 that includes details about the group chat session, users thereof, history of chat transcripts, and any other relevant information known to one of skill in the art.

This historical group chat session record is stored to a memory for future use, and may be relied upon to revive the group chat session should matching conditions present themselves in the future, such as a weekly meeting between the same participants, a group of people chatting about Monday Night Football each week, a notice being sent out to all members of a distribution list for periodic event notification like retail sales, reminders about activities to be performed like sporting events, concerts, etc., or any other conceivable use of the same group chat session in the future.

In one exemplary embodiment, using an exemplary chat application operating in interactive mode, a first user states: “I want to sell my car.” the first user receives a pop-up message via the chat application that states: “There is a group of users interested in buying a car in Austin, Tex. area. Would you like to join this group chat session?” In response, the first user responds affirmatively, such as by typing “OK.” The chat application then adds the first user to the temporary group chat session of users interested in buying a car. In an alternate approach, a new temporary group chat session may be created to accommodate the users who share an interest in the car being sold by the first user. Moreover, the chat application monitors messages across all users of the chat application for users interested in buying a car, such as by users typing “I want to buy a car.” Users who have indicated an interest in buying a car are then added to the temporary group chat session with the first user.

Additional filtering may take place on which users are added to the temporary group chat session by determining an extent of overlap between the interested car buying users and the first user and/or vehicle that the first user has for sale, such as distinguishing characteristics of the vehicle (make, model, price, condition, features, options, color, location, etc.). Should overlap between the first user and one or more interested car buying users be above a predetermined threshold, which may be determined dynamically to adjust a total membership in the group chat session to a manageable number of members (e.g., less than 50, 100, 500, 1000, members, etc., which may be adjusted by the first user and/or automatically selected by default), a group chat session is created. Otherwise, the group chat session is not created as there is not enough mutual interest in the car buying activity to justify the creation of the group chat session.

Once the car is sold, which may be indicated by the first user by stating: “the car is now sold,” the temporary group chat session is closed. All members of the temporary group chat session are removed from the group so that additional messages do not bother these other users.

In another exemplary embodiment, in proactive mode, a first user may indicate an interest in the 2016 Unicode conference. This interest may be indicated by searching for the 40th International Unicode Conference program, and in response, the chat application may proactively, without prompting from the first user, create a temporary group chat session for any users who share the same interest. The chat application then adds any users to the group chat session who are actively searching the same topic. As users are added and removed, information may be exchanged between the users in the temporary group chat session regarding the 2016 Unicode conference. After there are less than a predetermined number of users in the temporary group chat session, such as two members, the group chat session is destroyed as it has served its purpose.

According to another exemplary embodiment, in cognitive learning and analysis mode, an IT summit may be scheduled at 14:00-15:30 today, and users X, Y, and Z are planning to attend the event. The chat application detects the scheduled event from calendars of users, messages sent, etc., and identifies that the same event appears in the schedule of the three users X, Y, and Z. The chat application monitors context changes for the users and the scheduled event, for example, whether users X and Y searched for the same location: the Austin Convention Center, whether users X and Z booked at the same hotel, the Austin Hilton Downtown, whether users Y and Z booked car rentals for the same time period, the weekend spanning the conference, etc.

Once these overlapping context statuses are determined, the chat application may send an invitation to users X, Y, and Z indicating that a group chat session may be desired to coordinate plans for the conference, with each user having the option to join the temporary group chat session or not. This invitation may be restricted by security settings for one or more of the users, for example, user Z may wish to not share geographical location information with unknown users, and therefore the overlap of location may not be determined for user Z, and the invitation to the temporary group chat session will not be sent to user Z, only users X and Y.

After creation of the temporary group chat session, the session is monitored continuously or periodically to determine whether the group chat session is still needed and/or desired, based at least in part on activity levels of the users within the group chat session. Once the group chat session has less than a predetermined number of members (due to members leaving the group) or falls inactive for a predetermined period of time, e.g., 1 minute, 5 minutes, 10 minutes, 30 minutes, 1 hour, 2 hours, 1 day, etc., the chat application kills the group chat session and all remaining members are removed from the group.

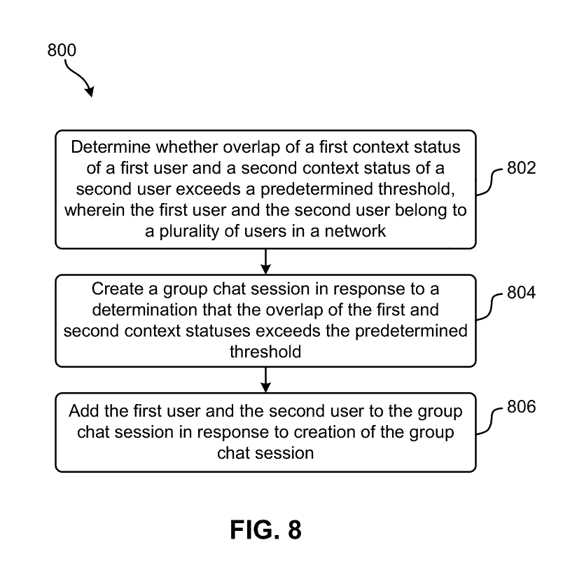

Now referring to FIG. 8, a method 800 is shown according to one embodiment. The method 800 may be performed in accordance with the present invention in any of the environments depicted in FIGS. 1-6, among others, in various embodiments. Of course, more or less operations than those specifically described in FIG. 8 may be included in method 800, as would be understood by one of skill in the art upon reading the present descriptions.

Each of the steps of the method 800 may be performed by any suitable component of the operating environment. For example, in various embodiments, the method 800 may be partially or entirely performed by a cloud server, a portable computer, a handheld or wearable computer, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more steps of the method 800. Illustrative processors include, but are not limited to, a microprocessor, a CPU, an ASIC, a FPGA, etc., combinations thereof, or any other suitable computing device known in the art.

As shown in FIG. 8, method 800 may start with operation 802, where a determination is made as to whether overlap of a first context status of a first user and a second context status of a second user exceeds a predetermined threshold. The first user and the second user belong to a plurality of users in a network.

Overlap is considered based on a number of matching factors common to both the first and second user. The factors may be selected from any of the following factors: interests, dislikes, location, age, gender, organizations, schools, professions, education levels, social behaviors, accessed forums, participation in discussion threads, calendared events, etc.

In operation 804, a group chat session is created in response to a determination that the overlap of the first and second context statuses exceeds the predetermined threshold. This group chat session is provided to the first and second users, along with any other users determined to have sufficient overlap of context status to be included in the group chat session.

In operation 806, the first user and the second user are added to the group chat session in response to creation of the group chat session. In this way, both users are able to send and receive messages from one another in the group chat session.

In a further embodiment, method 800 may include calculating context statuses for all users in the plurality of users, the context statuses being determined based on a predetermined number of factors, such as 4 factors, 6 factors, 8 factors, 10 factors, etc.

In another embodiment, method 800 may include monitoring the first context status of the first user, the second context status of the second user, and context statuses of the plurality of users within the network prior to and after creation of the group chat session. This monitoring process is used to determine current context statuses for the plurality of users in the network. Furthermore, method 800 may include detecting a context change affecting a context status of at least one user in the network and updating the context status of the at least one user in response to detection of the context change. Thereafter, method 800 may include determining whether overlap of context statuses of a subset of the plurality of users exceeds the predetermined threshold, and adding the subset of users to the group chat session in response to determination of the overlap of the context statuses of the subset of the plurality of users exceeding the predetermined threshold.

In yet another further embodiment, method 800 may include determining a security setting for the first user prior to adding the first user to the group chat session, and restricting the first user from being added to the group chat session in response to a determination that the security setting for the first user is violated due to adding the first user to the group chat session.

Furthermore, method 800 may include sending a message to the first user requesting permission to add the first user to the group chat session, and adding the first user to the group chat session in response to the first user granting permission to join the group chat session.

According to another embodiment, method 800 may include determining whether overlap of context statuses of all users added to the group chat session continues to exceed the predetermined threshold, and destroying the group chat session in response to a determination that overlap above the predetermined threshold does not exist for at least two context statuses of users in the plurality of users.

Method 800 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processor is configured to execute software logic to achieve functionality dictated by the software logic. The logic is configured to cause the processing circuit to perform method 800.

In another example, a computer program product may include a computer readable storage medium having program instructions embodied therewith. The computer readable storage medium may be any suitable storage device known in the art that is configured to store and allow computer access to information stored therein. The embodied program instructions are executable by a processing circuit to cause the processing circuit to perform method 800.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system, comprising:
a processing circuit; and
logic integrated with the processing circuit, executable by the processing circuit, or integrated with and executable by the processing circuit, the logic being configured to cause the processing circuit to:
determine whether overlap of a first context status of a first user and a second context status of a second user exceeds a predetermined threshold, wherein the first user and the second user belong to a plurality of users in a network;
create a group chat session in response to a determination that the overlap of the first and second context statuses exceeds the predetermined threshold; and
add the first user and the second user to the group chat session in response to creation of the group chat session.

2. The system as recited in claim 1, wherein the logic is further configured to cause the processing circuit to:
calculate context statuses for all users in the plurality of users, the context statuses being determined based on a predetermined number of factors selected from a group comprising: interests, dislikes, location, age, gender, organizations, schools, professions, education levels, social behaviors, accessed forums, participation in discussion threads, and calendared events.

3. The system as recited in claim 1, wherein the logic is further configured to cause the processing circuit to:
monitor the first context status of the first user, the second context status of the second user, and context statuses of the plurality of users within the network prior to and after creation of the group chat session;
detect a context change affecting a context status of at least one user in the network;
update the context status of the at least one user in response to detection of the context change;
determine whether overlap of context statuses of a subset of the plurality of users exceeds the predetermined threshold; and
add the subset of the plurality of users to the group chat session in response to determination of the overlap of the context statuses of the subset of the plurality of users exceeding the predetermined threshold.

4. The system as recited in claim 1, wherein the logic is further configured to cause the processing circuit to:
determine a security setting for the first user prior to adding the first user to the group chat session; and
restrict the first user from being added to the group chat session in response to a determination that the security setting for the first user is violated due to adding the first user to the group chat session.

5. The system as recited in claim 4, wherein the logic is further configured to cause the processing circuit to:
send a message to the first user requesting permission to add the first user to the group chat session; and
add the first user to the group chat session in response to the first user granting permission to join the group chat session.

6. The system as recited in claim 1, wherein the logic is further configured to cause the processing circuit to:
determine whether overlap of context statuses of all users added to the group chat session continues to exceed the predetermined threshold; and
destroy the group chat session in response to a determination that overlap above the predetermined threshold does not exist for at least two context statuses of users in the plurality of users.

7. A computer program product, the computer program product comprising a computer readable storage medium having program instructions embodied therewith, the embodied program instructions being executable by a processing circuit to cause the processing circuit to: determine, by the processing circuit, whether overlap of a first context status of a first user and a second context status of a second user exceeds a predetermined threshold, wherein the first user and the second user belong to a plurality of users in a network;
create, by the processing circuit, a group chat session in response to a determination that the overlap of the first and second context statuses exceeds the predetermined threshold; and
add, by the processing circuit, the first user and the second user to the group chat session in response to creation of the group chat session.

8. The computer program product as recited in claim 7, wherein the embodied program instructions are further executable by the processing circuit to cause the processing circuit to:
calculate, by the processing circuit, context statuses for all users in the plurality of users, the context statuses being determined based on a predetermined number of factors selected from a group comprising: interests, dislikes, location, age, gender, organizations, schools, professions, education levels, social behaviors, accessed forums, participation in discussion threads, and calendared events.

9. The computer program product as recited in claim 7, wherein the embodied program instructions are further executable by the processing circuit to cause the processing circuit to:
monitor, by the processing circuit, the first context status of the first user, the second context status of the second user, and context statuses of the plurality of users within the network prior to and after creation of the group chat session;
detect, by the processing circuit, a context change affecting a context status of at least one user in the network;
update, by the processing circuit, the context status of the at least one user in response to detection of the context change;
determine, by the processing circuit, whether overlap of context statuses of a subset of the plurality of users exceeds the predetermined threshold; and
add, by the processing circuit, the subset of the plurality of users to the group chat session in response to determination of the overlap of the context statuses of the subset of the plurality of users exceeding the predetermined threshold.

10. The computer program product as recited in claim 7, wherein the embodied program instructions are further executable by the processing circuit to cause the processing circuit to:
determine, by the processing circuit, a security setting for the first user prior to adding the first user to the group chat session; and
restrict, by the processing circuit, the first user from being added to the group chat session in response to a determination that the security setting for the first user is violated due to adding the first user to the group chat session.

11. The computer program product as recited in claim 10, wherein the embodied program instructions are further executable by the processing circuit to cause the processing circuit to:
send, by the processing circuit, a message to the first user requesting permission to add the first user to the group chat session; and
add, by the processing circuit, the first user to the group chat session in response to the first user granting permission to join the group chat session.

12. The computer program product as recited in claim 7, wherein the embodied program instructions are further executable by the processing circuit to cause the processing circuit to:
determine, by the processing circuit, whether overlap of context statuses of all users added to the group chat session continues to exceed the predetermined threshold; and
destroy, by the processing circuit, the group chat session in response to a determination that overlap above the predetermined threshold does not exist for at least two context statuses of users in the plurality of users.

13. A method, comprising:
determining whether overlap of a first context status of a first user and a second context status of a second user exceeds a predetermined threshold, wherein the first user and the second user belong to a plurality of users in a network;
creating a group chat session in response to a determination that the overlap of the first and second context statuses exceeds the predetermined threshold; and
adding the first user and the second user to the group chat session in response to creation of the group chat session.

14. The method as recited in claim 13, further comprising:
calculating context statuses for all users in the plurality of users, the context statuses being determined based on a predetermined number of factors selected from a group comprising: interests, dislikes, location, age, gender, organizations, schools, professions, education levels, social behaviors, accessed forums, participation in discussion threads, and calendared events.

15. The method as recited in claim 13, further comprising:
monitoring the first context status of the first user, the second context status of the second user, and context statuses of the plurality of users within the network prior to and after creation of the group chat session;
detecting a context change affecting a context status of at least one user in the network;
updating the context status of the at least one user in response to detection of the context change;
determining whether overlap of context statuses of a subset of the plurality of users exceeds the predetermined threshold; and
adding the subset of the plurality of users to the group chat session in response to determination of the overlap of the context statuses of the subset of the plurality of users exceeding the predetermined threshold.

16. The method as recited in claim 13, further comprising:
determining a security setting for the first user prior to adding the first user to the group chat session; and
restricting the first user from being added to the group chat session in response to a determination that the security setting for the first user is violated due to adding the first user to the group chat session.

17. The method as recited in claim 16, further comprising:
sending a message to the first user requesting permission to add the first user to the group chat session; and
adding the first user to the group chat session in response to the first user granting permission to join the group chat session.

18. The method as recited in claim 13, further comprising:
determining whether overlap of context statuses of all users added to the group chat session continues to exceed the predetermined threshold; and
destroying the group chat session in response to a determination that overlap above the predetermined threshold does not exist for at least two context statuses of users in the plurality of users.
